(19) United States
(12) Patent Application Publication
(10) Pub. No.: US 2024/0141950 A1
(43) Pub. Date: May 2, 2024

(54) SCREW LOCKING UNIT STRUCTURE

(71) Applicant: ASIA VITAL COMPONENTS CO., LTD., New Taipei City (TW)

(72) Inventors: Sheng-Huang Lin, New Taipei City (TW); Chii-Ming Leu, New Taipei City (TW)

(21) Appl. No.: 18/139,918

(22) Filed: Apr. 26, 2023

(30) Foreign Application Priority Data
Sep. 19, 2022 (TW) 111135397

(51) Int. Cl. F16B 39/284; F16B 39/38

(52) U.S. Cl. CPC F16B 39/284; F16B 39/38; F16B 2200/00

(57) ABSTRACT

A screw locking unit structure includes a screw main body having a head portion, a stem portion extended from a lower side of the head portion, a first screw locking section located below the stem portion, and a second screw locking section located below the first screw locking section; and an elastic element being externally fitted around the stem portion. The first screw locking section and the second screw locking section are externally provided with a first and a second male thread, respectively. The first and the second male thread are structurally different from one another to not only enable the screw main body to be temporarily held to an assembling interface before the latter is screw locked in place later, but also provide a function of stopping screwing automatically to prevent the second locking section extended through the assembling interface from being excessively screwed into a heat source.

This application claims the priority benefit of Taiwan patent application number 111135397 filed on Sep. 19, 2022.

### FIELD OF THE INVENTION

The present invention relates to a screw locking unit structure, and more particularly, to a screw locking unit structure including a screw main body, which can be temporarily held to a thermal module or a heat dissipating support for screw locking the latter to an object later.

### BACKGROUND OF THE INVENTION

Currently, screw locking elements are used to facilitate convenient connection of a heat dissipating unit to a heat source. The screw locking elements are tightened to four internally threaded corners of the heat dissipating unit through meshed threads of the screw locking elements and the threaded corners for the heat dissipating unit to closely contact with the heat source.

The screw locking elements can only be fixedly tightened in place at the time of connecting the heat dissipating unit to the heat source. That is, the screw locking elements could not be temporarily held to the heat dissipating unit before the latter is connected to the heat source. It consumes a lot of time for an operator at a work site to pick up the required screw locking elements and then use the same to tighten the heat dissipating unit to the heat source. Some manufacturers tried to fit a locating element on the heat dissipating unit and extend the screw locking element through the locating element, which axially limits the screw locking element from displacing or falling when being screwed into the heat dissipating unit. The locating element includes a sleeve, which is tight-fitted on or welded to a target location in advance. The sleeve internally defines a bore, through which the screw locking element is extended. The bore of the sleeve is internally provided with one or more protrusions or one annular rib; and the screw locking element for extending through the bore of the sleeve is externally provided with a radially outward protruded annular structure, which is diametrically larger than the original male thread on the screw locking elements. When the screw locking element is axially extended through the bore of the sleeve and the radially outward protruded annular structure passes the protrusions or the annular rib in the bore of the sleeve, the screw locking element is axially limited from moving in the sleeve reversely and is therefore, temporarily held in the sleeve. However, in the event the screw locking element having been limited in the sleeve is found damaged or has stripped teeth on the male thread, it would be impossible to remove the damaged screw locking element from the sleeve for reworking or changing, which of course causes many inconvenience in working.

Further, in the assembling operation on a production line, the screw locking element is generally tightened using an electric tool to ensure quick assembling speed. In this case, it is not able to control the tightening strength and screwing depth of the screw locking element, and the screw locking element is easily subjected to excessive tightening to damage the male thread of the screw locking element as well as the female thread in the corresponding internally threaded corner of the heat dissipating unit. It is therefore tried by the inventor to develop an improved screw locking unit structure to overcome the disadvantages in the prior art.

### SUMMARY OF THE INVENTION

A primary object of the present invention is to solve the above problems by providing an improved screw locking unit structure, a screw main body of which can be temporarily held to an assembling interface for screwing into an object later without being excessively screwed to damage a corresponding internally threaded bolt on the object.

Another object of the present invention is to provide the above screw locking unit structure, the screw main body of which can be exchanged for reworking at any time if it is damaged, and the screw main body would not separate from the assembling interface in the process of being further fixed to the object.

A further object of the present invention is to provide the above screw locking unit structure, which can reduce the time needed on a production line for tightening the screw main body thereof into a corresponding internally threaded location.

To achieve the above and other objects, the screw locking unit structure according to the present invention includes a screw main body and an elastic element. The screw main body includes a head portion, a stem portion extended from a lower side of the head portion, a first screw locking section located below the stem portion, and a second screw locking section located below the first screw locking section. The first screw locking section is externally provided with a first male thread, and the second screw locking section is externally provided with a second male thread. The first and the second male thread are differently structured. The elastic element is externally fitted around the stem portion of the screw main body to be limited between the head portion and the first screw locking section.

In the screw locking unit structure of the present invention, the first and the second male thread of are differently structured to have, for example, different thread pitches or different tightening directions, such that the first male thread can limit the screw main body temporarily held to an assembling interface from moving axially away from the assembling interface, and a joint between the first and the second male thread the screw main body can automatically stop the second male thread from being excessively screwed through the assembling interface into a corresponding internally threaded location on an object.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of a screw locking unit structure according to a first embodiment of the present invention;

FIG. 2 is a partially exploded perspective view of a screw locking unit structure according to a second embodiment of the present invention;

FIG. 3 is an assembled sectional side view of the screw locking unit structure of FIG. 2 in a non-screw-locked state;

FIG. 4 is another assembled sectional side view of the screw locking unit structure of FIG. 2 in a screw-locked state; and

FIG. 5 is a partially exploded perspective view showing the use of a screw locking unit structure according to a third embodiment of the present invention.

### DETAILED DESCRIPTION OF THE PREFERRED EMBODIMENTS

The present invention will now be described with some preferred embodiments thereof. For the purpose of easy to understand, elements that are the same in the preferred embodiments are denoted by the same reference numerals.

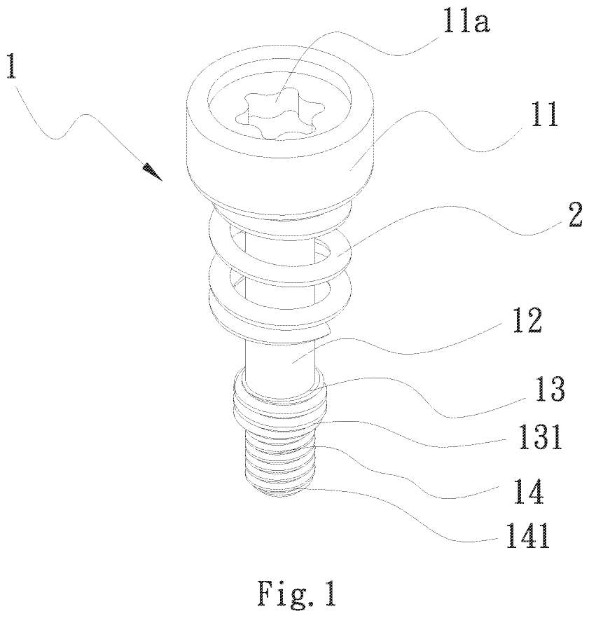

Please refer to FIG. 1, which is an assembled perspective view of a screw locking unit structure according to a first embodiment of the present invention. As shown, the screw locking unit structure in the first embodiment includes a screw main body 1 and an elastic element 2.

The screw main body 1 includes a head portion 11, a stem portion 12 extended from a lower side of the head portion 11, a first screw locking section 13 located below the stem portion 12, and a second screw locking section 14 located below the first screw locking section 13. That is, the second screw locking section 14 is located at a lower end of the screw main body 1. The first screw locking section 13 is externally provided with a first male thread 131, and the second screw locking section 14 is externally provided with a second male thread 141. The first male thread 131 has a structure different from that of the second male thread 141. And, the first screw locking section 13 is diametrically larger than the second screw locking section 14.

The first male thread 131 can be any one of an Imperial unit coarse thread, an Imperial unit fine thread and a Metric unit thread; and the second male thread 141 can be one of an Imperial unit coarse thread, an Imperial unit fine thread and a Metric unit thread other than that of the first male thread 131. The first male thread 131 can be any one of a left-hand and a right-hand thread, and the second male thread 141 can be one of the left-hand and the right-hand thread other than that of the first male thread 131. That is, the first and the second male thread 131, 141 can be two differently featured male threads selected from the group consisting of above listed male threads.

The head portion 11 is provided at an upper end surface with a socket 11a for engaging with a correspondingly configured hand tool, such as a flat-head, a crosshead, an inner hexagon, or a star head hand tool.

The elastic element 2 is externally fitted around the stem portion 12 of the screw main body 1 and located between the head portion 11 and the first screw locking section 13. The elastic element 2 can be a compression spring.

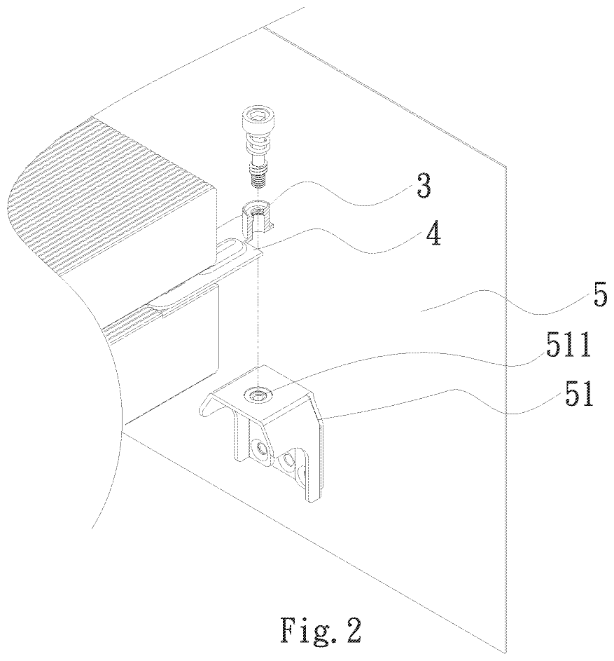

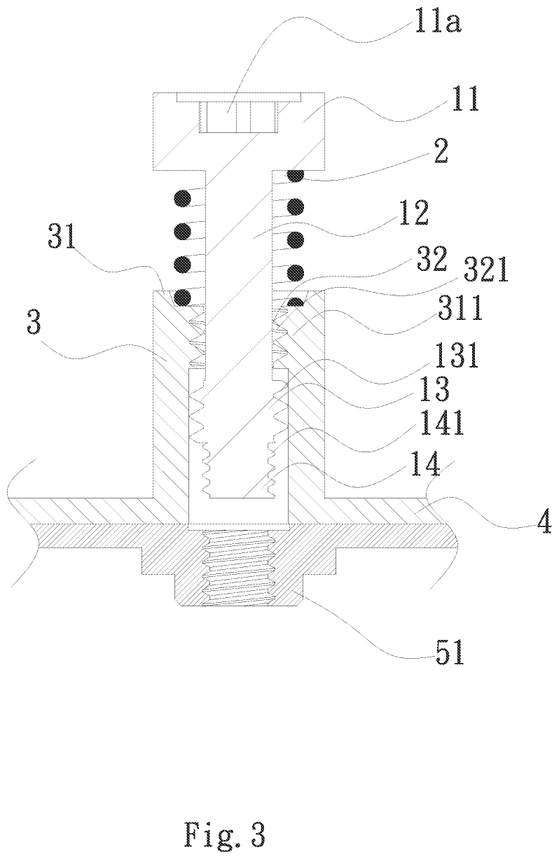

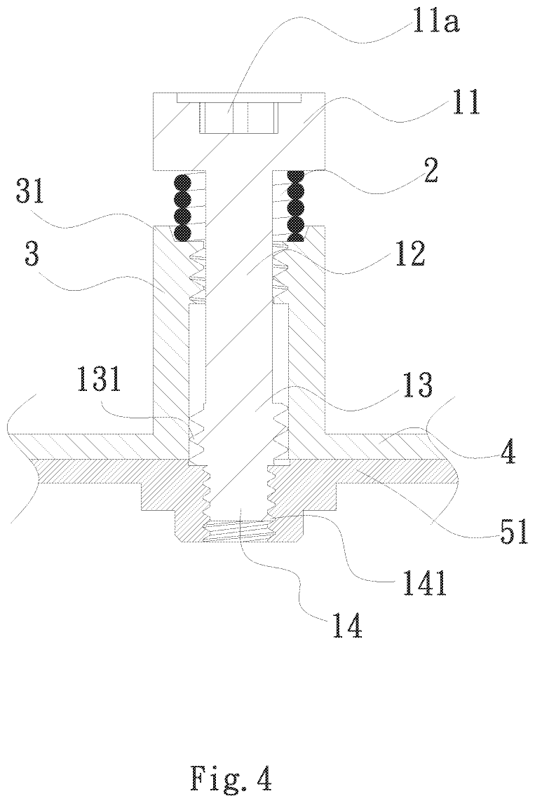

Please refer to FIGS. 2, 3 and 4, in which a screw locking unit structure according to a second embodiment of the present invention is shown. The second embodiment is generally structurally similar to the first one but it further includes a sleeve 3. The parts that are similar in the first and the second embodiment are not repeatedly described herein. In the second embodiment, the first male thread 131 is screwed into the sleeve 3. The sleeve 3 includes an upper end 31 and internally defines an axial bore 32. The upper end 31 is formed with an inner shoulder portion 311; and the axial bore 32 is extended through the inner shoulder portion 311 into the sleeve 3. A length of the axial bore 32 corresponding to the inner shoulder portion 311 is formed with a female thread 321 corresponding to the first male thread 131, so that the first male thread 131 can mesh with the female thread 321 to drive the screw main body 1 into the sleeve 3. At this point, the first screw locking section 13 is axially limited by the inner shoulder portion 311 to stop the screw main body 1 from moving out of the sleeve 3 and the elastic element 2 has an end elastically pressed against the lower side of the head portion 11 of the screw main body 1 and another end against an upper surface of the inner shoulder portion 311 of the sleeve 3.

In the second embodiment, the sleeve 3 is integrally formed on an assembling interface, which may be, for example, a heat dissipating support 4 or a heat radiating element. In the second embodiment, while the assembling interface is illustrated as a heat dissipating support 4, it is understood the present invention is not necessarily limited thereto. The sleeve 3 can be integrally formed on the heat dissipating support 4 through integral extrusion, deep drawing, or drawing.

The heat dissipating support 4 is to be screw-locked to a system-end interface, such as a heat source, a computer chassis, or a server cabinet. In the second embodiment, the system-end interface is illustrated as a computer chassis 5, which is only partially shown in FIG. 2. The computer chassis 5 includes at least one fixing bracket 51 provided at an area of the computer chassis 5 to be connected with the heat dissipating support 4. The fixing bracket 51 may be integrally formed on the computer chassis 5 by stamping, or be additionally connected to the computer chassis 5 by riveting, tight fitting, bonding, etc.

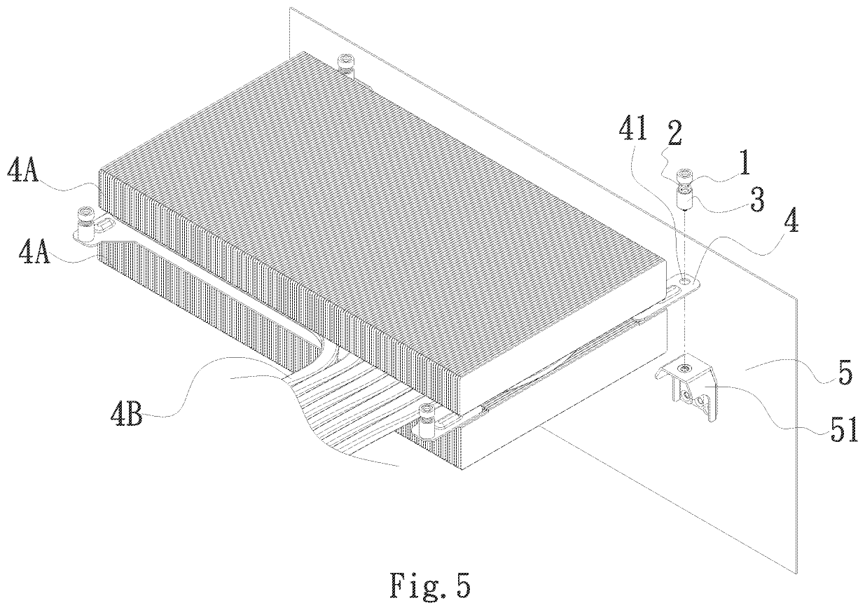

FIG. 5 shows a screw locking unit structure according to a third embodiment of the present invention. Please refer to FIG. 5 along with FIGS. 2, 3 and 4. The third embodiment is generally structurally similar to the second embodiment, except the sleeve 3 is an independent part being connected to the assembling interface using some connecting means. The parts that are similar in the second and the third embodiment are not repeatedly described herein. In the third embodiment, the assembling interface is non-restrictively shown as a heat dissipating support 4 for supporting a radiating fin assembly 4A and a plurality of heat pipes 4B thereon. The heat dissipating support 4 can be an integrally formed unit or an assembly with multiple parts. Mounting holes 41 are formed on the heat dissipating support 4 for respectively receiving one screw main body 1 therein. The sleeve 3 can be connected to the heat dissipating support 4 by welding, riveting, tight fitting, bonding, etc. With the sleeve 3, the screw main body 1 can be temporarily held to the heat dissipating support 4 before it is further screwed and tightened to the fixing bracket 51. Lastly, the heat dissipating support 4 is locked to the fixing bracket 51 by screwing the screw main body 1 through the mounting hole 41 into the fixing bracket 51. In this manner, the assembling time required on the production line can be reduced.

To preliminarily assemble the screw main body 1 to the sleeve 3, first extend the first screw locking section 13 and the second screw locking section 14 of the screw main body 1 through the axial bore 32 of the sleeve 3. The second screw locking section 14 located at the lower end of the screw main body 1 is the first part of the screw main body 1 to pass through the length of the axial bore 32 at the inner shoulder portion 311. Further, since the second screw locking section 14 is diametrically smaller than the axial bore 32, it can easily pass through the axial bore 32 without being hindered. When the first screw locking section 13 reaches the inner shoulder portion 311, the first male thread 131 externally formed on the first screw locking section 13 meshes with the female thread 321 formed on the length of the axial bore 32 corresponding to the inner shoulder portion 311, allowing the first screw locking section 13 to pass through the inner shoulder portion 311 into the sleeve 3. Since the sleeve 3 has been connected to the heat dissipating support 4 in advance, the screw main body 1 with the first and second screw locking sections 13, 14 extended into the sleeve 3 is now temporarily held to the heat dissipating support 4 without the risk of separating therefrom during transportation of the partially assembled screw locking unit structure and heat dissipating support 4. In the event the screw main body 1 temporarily held to the heat dissipating support 4 must be changed due to any damage thereof, simply pull and turn the screw main body 1 reversely for the first male thread 131 of the first screw locking section 13 to mesh with the female thread 321 on the axial bore 32 corresponding to the inner shoulder portion 311, and the screw main body 1 can be loosened from the axial bore 32 and removed from the sleeve 3.

To fixedly connect the heat dissipating support 4 to the computer chassis 5, first align each mounting hole 41 on the heat dissipating support 4 with an internally threaded hole 511 formed on one corresponding fixing bracket 51 and then turn the screw main bodies 1 further into the sleeve 3, such that the second male thread 141 on the second screw locking section 14 at the lower end of the screw main body 1 is extended into and engaged with the internally threaded hole 511 to lock the heat dissipating support 4 to the computer chassis 5.

Since the first male thread 131 and the second male thread 141 selected for use are different in structure, such as being different in tightening directions or thread pitches, the screw locking of the second screw locking section 14 of the screw main body 1 into the fixing bracket 51 would automatically stop when a joint between the structurally different second male thread 141 and first male thread 131 reaches the fixing bracket 51, and the second male thread 141 is prevented from being excessively threaded into the fixing bracket 51. Further, the elastic element 2 with two ends elastically pressed against the lower side of the head portion 11 of the screw main body 1 and the upper surface of the inner shoulder portion 311 of the sleeve 3 also provides the screw main body 1 a good anti-loosening effect.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A screw locking unit structure, comprising:
a screw main body including a head portion, a stem portion extended from a lower side of the head portion, a first screw locking section located below the stem portion, and a second screw locking section located below the first screw locking section; the first screw locking section being externally provided with a first male thread and the second screw locking section being externally provided with a second male thread; and the first male thread and the second male thread being different in their tightening directions;
an elastic element being externally fitted around the stem portion of the screw main body and located between the head portion and the first screw locking section; and
a sleeve being integrally formed on or previously connected to an assembling interface; the sleeve including an upper end and internally defining an axial bore; the upper end being formed with an inner shoulder portion, and a length of the axial bore extended through the inner shoulder portion being formed with a female thread corresponding to the first male thread; and
wherein when the screw main body is extended into the sleeve with the first male thread on the first screw locking section of the screw main body meshed with the female thread on the sleeve and two opposite ends of the elastic element elastically pressed against the lower side of the head portion of the screw main body and an upper surface of the inner shoulder portion, the screw main body can be held temporarily to the assembling interface before the latter is screw locked to a heat source; and the first and the second male thread with different tightening directions provide a function of stopping screwing automatically to prevent the second screw locking section extended through the assembling interface from being excessively screwed into the heat source.

2. The screw locking unit structure as claimed in claim 1, wherein the elastic element is a compression spring.

3. The screw locking unit structure as claimed in claim 1, wherein the first male thread is one of a right-hand thread and a left-hand thread; while the second male thread is another one of the right-hand and the left-hand thread.

4. The screw locking unit structure as claimed in claim 1, wherein the first screw locking section is diametrically larger than the second screw locking section.

5. The screw locking unit structure as claimed in claim 1, wherein the second screw locking section is located at a lower end of the screw main body.

6. The screw locking unit structure as claimed in claim 1, wherein the assembling interface is one of a heat dissipating support and a heat radiating element.
